(19) United States
(12) Patent Application Publication
(10) Pub. No.: US 2005/0249924 A1
(43) Pub. Date: Nov. 10, 2005

(54) Decorative surface covering having a discontinuous digitally printed layer and an analog print layer, and the method of making the same

(76) Inventors: David P. Reichwein, Elizabethtown, PA (US); Timothy B. Burk, York, PA (US); Matthew S. Myers, Lititz, PA (US); Sunil Ramachandra, Lancaster, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/092,483

(22) Filed: Mar. 29, 2005

Related U.S. Application Data
(60) Provisional application No. 60/568,426, filed on May 5, 2004.

(51) Int. Cl. B42D 15/00; B32B 33/00

(52) U.S. Cl. 428/195.1; 283/117

(57) ABSTRACT

A decorative surface covering having a substrate, a first print layer adhered to one surface of the substrate, and second discontinuous print layer is made by printing a first print layer on one surface of the substrate and printing a second discontinuous print layer over the first print layer. The first print layer is applied by rotogravure, transfer or flexographic printing. The second print layer is digitally printed. The print layers can be printed directly onto the substrate or printed onto a film and the film laminated to the substrate.

This invention is directed to a decorative surface covering having a design pattern formed by two print layers. The first print layer has a decorative design applied by rotogravure printing, transfer printing, flexographic printing or other analog printing method. The second print layer has a discontinuous design that is applied by digital printing, whereby a portion of the first print layer and/or substrate is visible through the second print layer. The second print layer can be applied directly to the substrate that has the first print layer previously applied to it or applied to a free-standing transparent or translucent film that is then laminated to the surface covering.

### BACKGROUND OF THE INVENTION

For the purpose of this application, the term “decorative surface covering” is intended to include not only floor coverings and wall coverings, but also moldings and transition trim pieces.

Flexography is an offset technique where the printing plates or cylinders are made from rubber or photopolymers. The printing has been accomplished by the transfer of ink from the raised surface of the printing plate to the surface of the material being printed. The rotogravure method of printing uses a print cylinder with thousands of tiny cells which are below the surface of the printing cylinder. The ink is transferred from the cells when the print cylinder is brought into contact with the pressure sensitive label at the impression roll. Printing inks for flexography or rotogravure include solvent based inks, water based inks, and radiation cured inks. While rotogravure and flexography printing does provide acceptable image quality and have been used to print designs onto decorative surface coverings, either directly or by being printed on a transparent or translucent film that is laminated to the decorative surface covering substrate, they are limited to repeatable patterns.

Recently, digital printing has become a viable method for the printing of information on packages. The term “digital printing” refers to the electronic digital characters or electronic digital images that can be printed by an electronic output device capable of translating digital information. The two main digital printing technologies are ink jet and electrophotography.

The introduction of piezo impulse drop-on-demand (DOD) and thermal DOD ink jet printers in the early 1980's provided ink jet printing systems. These early printers were very slow, and the ink jet nozzles often clogged. In the 1990's Hewlett Packard introduced the first monochrome ink jet printer, and shortly thereafter, the introduction of color, wide format ink jet printers enabled businesses to enter the graphic arts market. Today, a number of different ink jet technologies are being used for packaging, desktop, industrial, commercial, photographic, and textile applications.

In piezo technology, a piezo crystal is electrically excited to create pressure waves, which eject ink from the ink chamber. The ink can be electrically charged and deflected in a potential field, allowing the different characters to be created. More recent developments have introduced DOD multiple jets that utilize conductive piezo ceramic material which, when charged, increases the pressure in the channel and forces a drop of ink from the end of the nozzle. This allows for very small droplets of ink to form and be delivered at high speed at very high resolution, approximately 1,000 dpi printing.

Until recently, the use of color pigments in jet inks was uncommon. However, this is changing rapidly. Submicron pigments were developed in Japan for ink jet applications. Use of pigments allows for more temperature resistant inks required for thermal ink jet printers and laminations. Pigmented water-based jet inks and UV-curable jet inks are commercially available. Pigmented inks have greater lightfastness and water-resistance.

The concept of digital printing for decorative applications exists in prior art, however, the present invention relates to new techniques and applications. Among these are the use of evolving digital printing hardware in combination with other printing techniques to develop unique design patterns for surface covering, particularly flooring, applications.

### SUMMARY OF THE INVENTION

The present invention can be used to produce resilient tiles and sheet goods with custom images. Pad coats are useful to hide the tile and sheet substrates. Pad coats are typically opaque and white or light in color. If the pad coat has a smooth, flat surface, the wood pattern can be printed on the pad coat with a rotogravure press.

Rotogravure printing, as well as flexographic printing and transfer printing of commercial surface coverings, uses printing plates or cylinders to apply the ink forming the decorative print layer. Therefore, the printed decorative pattern repeats.

There is a demand for decorative surface coverings having non-repeating or custom patterns. Digital printing is controlled by a computer that allows the printing of non-repeating, random patterns. However, present technology does not permit the rapid printing of six foot wide sheet goods. Even the digital printing of tile products is fairly slow.

Further, the cost of the print cylinders does not permit the production of short run unique custom patterns. The time and effort to changeover cylinders, also makes short production runs infeasible.

### DETAILED DESCRIPTION OF THE INVENTION

By combining digitally printed highlights with a flexographic, rotogravure or transfer printed substrate, a decorative surface covering having a non-repeating pattern can be produced at line speeds that are compatible with economic commercial production. With or without a pad coat, the conventional flexographic, rotogravure or transfer printed layer may hide the substrate. The digitally printed highlights can be printed at the same speed as the flexographic, rotogravure or transfer printed layers and may result in a non-repeating pattern.

Further, since programming the computer is relatively inexpensive and since the computer control permits rapid changeover from one design to another design, it is economically feasible to produce short runs of decorative surface coverings having custom patterns. Additionally, this increases the flexibility of the manufacturing process without the significant production of waste or scrap material.

Optionally, an opaque pad coat can be applied to the substrate. The pad coat may be white or another color. The pad coat can be applied by any known method, including by a reverse roll coater. The pad coat can be digital printed if the width of the substrate is fairly narrow, such as the case in making tile, molding or transition trim pieces. If a pad coat is used, the flexographic, rotogravure or transfer printed layer is applied over the pad coat and the digitally printed layer is applied over the flexographic, rotogravure or transfer printed layer.

The flexographic, rotogravure or transfer printed layer may be discontinuous, if it is desired to have the substrate visible to form a portion of the design pattern. The digitally printed layer can either fully or partially fill the discontinuities in the analog printed layer. If the digitally printed layer partially fills the discontinuities in the analog printed layer, the substrate will be visible in portions of the design pattern. Further, the digitally printed pattern can either be printed on the discontinuous analog printed layer, or overlap the discontinuous analog printed layer and also directly overlie the substrate.

In another embodiment, the pad coat and/or printed layers can be applied to a free-standing film, which film can be laminated to a substrate to form the surface covering. The free-standing film can be a transparent, translucent or opaque film or an opaque paper with at least one of the print layers applied to the film or paper. The free-standing film can also optionally include a pad coat. When laminated to a substrate, the transparent or translucent film can act as a wear layer.

If the film is transparent or translucent, the digitally printed layer can be interposed between the transparent or translucent film and the rotogravure, flexographic or transfer printed layer, or the transparent or translucent film can be interposed between the digitally printed layer and the rotogravure, flexographic or transfer printed layer. In another embodiment, only the digitally printed layer or the rotogravure, flexographic or transfer printed layer is applied to the transparent or translucent film. In either embodiment, the printed free-standing film may be laminated to the substrate.

If the free-standing film has only the digitally printed layer applied to it, the rotogravure, flexographic or transfer printed layer is applied to the substrate before the free-standing film is laminated to the substrate. The free-standing film may be laminated to the substrate with the digitally printed layer either adjacent or distal the rotogravure, flexographic or transfer printed layer. If the digitally printed layer is interposed between the transparent or translucent film and the rotogravure, flexographic or transfer printed layer, the film may function as a wear layer.

If the free-standing film has only the rotogravure, flexographic or transfer printed layer applied to it, the film is laminated to the substrate prior to applying the digitally printed layer. Depending on whether it is desired to have the rotogravure, flexographic or transfer printed layer adjacent the digitally printed layer, the rotogravure, flexographic or transfer printed layer is interposed between the substrate and the transparent or translucent film, or the transparent or translucent film is adjacent the substrate when the free-standing film is laminated to the substrate.

Digital printing ink is characterized by a viscosity and particle size that permits application with an ink jet. The digital printing ink can be water-based, solvent-based or 100% solids. The 100% solids inks are typically UV cured.

Since the application of the digital print ink can be controlled by a computer, the digital pattern can be repeated in a looped pattern or be non-repeating. The non-repeating pattern is obtained by using a computer algorithm. By using an algorithm to generate the pattern as it is being applied, the repeat length can be infinite.

If the pattern loops or repeats, it is desirable to have the pattern on each side of the pattern splice merge so that there is no abrupt, noticeable change or break in the pattern. Depending on how much computer memory is used, the length of the loop can be varied and easily exceed 60 inches, which is the typical maximum length of the decorative surface coverings.

The pattern can also be varied by developing a number of pattern segments with similar designs at the beginning and end points. Then the segments can be randomly selected to vary the pattern without an abrupt or noticeable change or break in the pattern.

The pattern can also be varied by moving the print head while it is applying the ink. This results in a dynamic pattern. If the print head is moved in a random manner or the computer is programmed to randomly select loop segments or the print images are randomly selected, a random pattern results.

To commercially produce the decorative surface covering of the present invention, the manufacturing line includes a rotogravure press, flexographic press, offset press, such as a print transfer press, or other analog printing press, followed by at least one digital print head. For efficiency and to minimize the space required to produce the decorative surface covering, the press and digital print head can be mounted on the same frame.

To be able to digitally print at increased line speeds, multiple digital print heads may be used. Further to create a dynamic print design one or more digital print heads can be mounted on the frame to be able to traverse across the substrate as it is being printed.

1. A decorative surface covering comprising a substrate, a first print layer adhered to one surface of the substrate and a second print layer adhered to the one surface of the substrate, the second print layer being discontinuous, the first print layer comprising an analog printing ink, the second ink being a digital printing ink.

2. The decorative surface covering of claim 1, wherein the first print layer is discontinuous and at least a portion of the second print layer overlies the first print layer.

3. The decorative surface covering of claim 1, wherein the first print layer is discontinuous and wherein the first print layer and second print layer are adhered directly to the substrate.

4. The decorative surface covering of claim 1, wherein the second print layer forms a continuous looped pattern having no abrupt change in the pattern.

5. The decorative surface covering of claim 4, wherein the looped pattern comprises a plurality of pattern segments having different designs.

6. The decorative surface covering of claim 5, wherein the pattern segments are randomly selected.

7. The decorative surface covering of claim 1, wherein the second print layer is applied to the substrate in a dynamic pattern.

8. The decorative surface covering of claim 1, wherein the second ink is applied to the substrate in a random pattern.

9. A free-standing printed film comprising a film selected from the group consisting of a transparent film, a translucent film, an opaque film and an opaque paper, a first print layer comprising an analog ink and a second print layer comprising a digital ink, wherein the second print layer is discontinuous.

10. The free-standing printed film of claim 9, wherein the film is interposed between the first and second print layers.

11. The free-standing printed film of claim 9, wherein the second layer is interposed between the film and the first print layer.

12. The free-standing printed film of claim 9, wherein the first and second print layers are the same side of the film, the first print layer is discontinuous, and at least a portion of the first print layer overlies the second print layer.

13. The free-standing printed film of claim 9, wherein the first and second print layers are the same side of the film, the first print layer is discontinuous, and the first print layer and second print layer are adhered directly to the film.

14. A method of making a decorative surface covering comprising providing a substrate, applying a first print layer to one surface of the substrate, and applying a second discontinuous print layer to the one surface of the substrate, the first print layer being applied by an analog printing method, the second print layer being applied by digital printing, the second print layer being discontinuous.

15. The method of claim 14, wherein the first print layer is discontinuous.

16. The method of claim 15, wherein the first print layer is applied directly to the substrate and at least a portion of the second print layer is applied directly to the first print layer.

17. The method of claim 14, wherein a transparent or translucent layer is interposed between the first print layer and the second print layer.

18. The method of claim 14, wherein the first print layer and the second print layer are applied to a film, the film being selected from the group consisting of a transparent film, a translucent film, an opaque film and an opaque paper, and wherein the printed film is laminated to the substrate.

19. The method of claim 18, wherein the first print layer and the second print layer are printed on opposite sides of the film.

20. The method of claim 18, wherein the second print layer is printed on one side of the film, the first print layer is then printed on the same side of the film and the printed film is laminated to the substrate with the first print layer adjacent the substrate.

21. The method of claim 14, wherein the second print layer printed is in a continuous looped pattern having no abrupt change in the pattern.

22. The method of claim 21, wherein the looped pattern comprises a plurality of pattern segments having different designs and wherein the pattern segments are randomly selected.

23. The method of claim 14, wherein the second print layer is applied to the substrate in a dynamic pattern.

24. The method of claim 14, wherein the second ink is applied to the substrate in a random pattern.
